(19) United States
(12) Patent Application Publication
(10) Pub. No.: US 2010/0299680 A1
(43) Pub. Date: Nov. 25, 2010

(54) Novel JMS API for Standardized Access to Financial Market Data System

(76) Inventors: Andrew Macgaffey, Carol Stream, IL (US); Peter Lankford, Chicago, IL (US)

Correspondence Address: ANDREW MacGAFFEY;METAFLUENT, 4320 WINFIELD RD SUITE 200, WARRENVILLE, IL, 60555, US

(21) Appl. No.: 12/448,485

(22) PCT Filed: Jan. 25, 2008
(86) PCT No.: PCT/US2008/000963

§ 371 Date: Jun. 22, 2009

Related U.S. Application Data
(60) Provisional application No. 60/897,750, filed on Jan. 26, 2007.

(51) Int. Cl. G06F 9/46

(52) U.S. Cl. 719/328

(57) ABSTRACT

The invention provides a system and method whereby an Application may use a standard API to access and deliver financial market data from multiple proprietary Market Data Systems. In the preferred embodiment, a JMS API is used, along with a small set of conventions, that enable an application to access market data from Market Data Systems though a standardized interface using the JMS publish/subscribe paradigm, and wherein said standardized interface relies on a small set of conventions to convey market data semantics via the standard JMS message property construct.

### RELATED APPLICATIONS

This application claims priority from U.S. provisional 60/897750 by the same inventors, filed Jan. 26, 2007, the entirety of which is incorporated by reference as if fully set forth herein. The application further relates to the inventions taught in co-pending patent application by the same inventors originally filed as U.S. provisional application 60/783,369, and currently pending as PCT/US2007/006501, PCT/US2007/006500, and PCT/US2007/006426, all with a priority date of Mar. 18, 2006, the entireties of which are incorporated by reference as if fully set forth herein.

### GOVERNMENT FUNDING

None

### FIELD OF INVENTION

The invention relates to the field of database access and data delivery, and more particularly to retrieval of data, irrespective of whether a given data system employs a proprietary application programming interface (API), and in particular data from systems in the field of financial markets.

### BACKGROUND

No standard application programming interface (API) currently exists for accessing financial market data systems. Each market data system, such as, for example the Reuters Market Data System (RMDS), uses its own proprietary application programming interface (API). Because each Market Data System uses a different set of APIs, applications developed for one system will not work on another. Further, the application developer is required to learn a different API for each type of system. This increases training and support costs for the organization that is developing applications.

Bridges can be built between Market Data Systems and off-the-shelf JMS providers (IBM, TIBCO, Sonic, etc.) but bridges are not practical for a number of reasons. A bridge would expose some application-level protocols above the JMS API, and an application built to the JMS API would have to participate in these protocols, adding complexity to the application and moving the application away from the standard.

Moreover, some requirements for market data include data condition notifications, which are not available via typical commercially available off-the-shelf JMS implementations. Implementing heartbeats and timeouts in an application-level protocol above the JMS API is one possibility, but is not a practical solution because it adds complexity, computational cost and does not scale well.

What is needed is an efficient means to access multiple Market Data Systems and/or switch from one Market Data System to another. What is further needed is an API based on a commercially available standard that provides access to financial market data systems.

### SUMMARY OF THE INVENTION

The invention taught herein meets at least the foregoing unmet needs. The invention provides a means for an application to access multiple Market Data Systems and to switch from one Market Data System to another. The invention defines a small set of application-level protocol conventions that, in conjunction with the basic JMS API, functionally constitute a “standard” interface to market data systems.

As described in three currently co-pending patent applications by the same inventors (originally filed as U.S. application No. 60/783,369, and currently pending as PCT/US2007/006501, PCT/US2007/006500, and PCT/US2007/006426), the required properties in a preferred embodiment of the invention are:
Message type—to distinguish different types of messages {status, image, update, stream_update}
Status code—to convey request responses {ok, invalid, denied, closed}
Data condition code—to convey data condition {ok, stale}
Text—to convey information text for human users
Data stream id—differentiates multiple data streams on one topic for the purpose of delivering collections, such as order books. A long integer.
Next/previous stream ids—to convey ordered collections. A long integer.

The invention provides multiple implementations of the standard. In the preferred embodiment, the invention presupposes a step of mapping the JMS interface onto an underlying programming interface. Thus, the user of the invention is not required to do mapping of any kind. It can be appreciated that the application may need to initialize the API slightly differently for different implementations, however, even this dependency can be eliminated with appropriate use of runtime configuration mechanisms.

The invention provides a standards-based API such that delivery of market data via such standards-based API shields the application from proprietary technology. According to the invention, an application can use a single API to access multiple different Market Data Systems, individually or simultaneously, or switch from one to another with little or no effort

The current invention provides a standard application interface compatible with multiple proprietary APIs. The invention further provides a means to exploit the underlying Market Data System for transport, permissioning, and other functions integral to the accessing and delivery of financial market data to data subscribers. The invention provides a means to create a functional, standard API that will operate in conjunction with multiple Market Data Systems.

The invention provides a method and system for creating and using an API capable of accessing and delivering market data, whether or not from proprietary APIs, via a standards-based API. According to the invention, JMS API plus a small set of conventions constitutes an abstraction layer that, as an interface, operates to hide or shield applications from the specific details of the underlying implementation, which may involve one or more different proprietary APIs or network protocols.

In an embodiment according to the invention, a programming library (e.g. Java jar file, C# or C++ DLL) delivers market data via the Java Message Service (JMS) API, thereby enabling an application to access financial market data using the JMS publish/subscribe messaging paradigm through a standardized interface, and this standardized interface delivers market data as JMS MapMessages. By relying on a small set of conventions, the standardized interface is able to convey market data semantics via the standard JMS message property construct.

In the preferred embodiment the invention also provides a method and system enabling an Application to subscribe to financial market data through an interface, such as JMS. According to the invention, the basic sequence of events for an Application subscribing to market data is as follows:
a) Application allocates a TopicConnectionFactory.
b) Application requests a TopicConnection from the TopicConnectionFactory.
c) TopicConnectionFactory allocates a TopicConnection—the specific type of TopicConnection allocated may vary depending on external configuration, and simultaneous use of multiple types of connections is to be expected—although these details are hidden from the Application.
d) TopicConnection authenticates Application.
e) Application “starts” the TopicConnection.
f) TopicConnection allocates any necessary resources (including separate light-weight threads if necessary) so as to maintain and operate a connection to the underlying Market Data System.
g) Application requests a TopicSession from the TopicConnection.
h) Application requests a Topic from the TopicSession.
i) TopicSession allocates and saves a reference to the requested Topic.
j) Application obtains a TopicSubscriber for the Topic from the TopicSession.
k) TopicSession initiates a subscription with the underlying Market Data System, mapping the Topic name to the naming conventions of the underlying Market Data System as required.
l) TopicSession receives messages in the underlying native format of the Market Data System and converts them to JMS MapMessage with the appropriate application-level conventions as defined by this invention
m) Application receives a stream of MapMessages via the TopicSubscriber and interprets the message properties according to the application-level conventions, and uses the MapMessage interface to access data values by name.
n) Application uses the TopicSession to un-subscribe from the Topic.
o) TopicSession tracks the number of active subscriptions and, when the number is zero, releases any subscriptions and associated resources allocated within the underlying Market Data System.

The invention provides two implementation techniques. The first entails embedding one or more third-party proprietary APIs that provide access to one or more underlying Market Data Systems. The second entails effectively hiding the details of an exposed network protocol. In such cases, there is no underlying API to embed; there is still a benefit to application developers in the inventive approach that hides the details of interacting with some system via an exposed network protocol. An application using the invention would interact with the system in the same way (as defined by the invention) regardless of whether the system provides an API or not. By these two techniques, the invention successfully subscribes to virtually all current Market Data Systems and associated network protocols.

This invention applies to all types of applications that might be developed to use proprietary APIs for the various Market Data Systems on the market.

### DETAILED DESCRIPTION OF THE PREFERRED EMBODIMENT

The current invention provides a standard interface to access financial market data systems, while using the underlying Market Data System for transport, permissioning, etc. The inventive method of providing a standard API enables the developer to write an application once that will operate in conjunction with multiple Market Data Systems.

The invention enables an application to access financial market data using the JMS publish/subscribe messaging paradigm through a standardized interface. This interface delivers market data obtained from proprietary databases in the form of JMS MapMessages, and relies on a small set of conventions to convey market data semantics via the standard JMS message property construct.

As described in three currently co-pending patent applications by the same inventors (originally filed as U.S. application No. 60/783,369, and currently pending as PCT/US2007/006501, PCT/US2007/006500, and PCT/US2007/006426), the required properties in a preferred embodiment of the invention are:
Message type—to distinguish different types of messages {status, image, update, stream_update}
Status code—to convey request responses {ok, invalid, denied, closed}
Data condition code—to convey data condition {ok, stale}
Text—to convey information text for human users
Data stream id—differentiates multiple data streams on one topic for the purpose of delivering collections, such as order books. A long integer.
Next/previous stream ids—to convey ordered collections. A long integer.

An alternate embodiment of this invention uses fields within the message instead of the JMS property construct to convey market data semantics. However, in such an embodiment the user is constrained in the field namespace.

The invention relies on one of two implementation techniques. The first entails embedding one or more third-party proprietary APIs that provide access to one or more underlying Market Data Systems. The second entails effectively hiding the details of an exposed network protocol. In such cases, there is no underlying API to embed; there is still a benefit to application developers in the inventive approach that hides the details of interacting with some system via an exposed network protocol. An application using the invention would interact with the system in the same way (as defined by the invention) regardless of whether the system provides an API or not. By these two techniques, the invention successfully subscribes to virtually all current Market Data Systems and associated network protocols.

As used herein, the term “Market Data System” means any financial market data system, middleware, real-time data feeds, direct exchange feeds, order management systems, and complex event processing systems. Examples of Market Data Systems (and examples of their Application Programming Interfaces—APIs—and protocols) covered by this invention are set forth below.

Market data middleware such as Reuters Market Data System (RMDS): SSL, RSSL, SFC, RFA; Wombat Financial Software system: MAMA, MAMDA, PAPA; IBM WebSphere Front Office; Exegy Ticker Plant; Infodyne TPS+: IMDA, ITCL; Bloomberg: BBComm; ActivFinancial; Rai Technology; Caplin; Arcontech; Imagnos.
Real-time datafeeds such as Reuters Datafeed; Reuters Datafeed Direct; Bloomberg BPipe; Thomson Data Feeds; Comstock PlusFeed; Telekurs MDF+; GLTrade Topic.
Direct exchange feeds such as NASDAQ Totalview; NASDAQ ITCH 2; NASDAQ UTP; ARCABook; SIAC CTA; NYSE OpenBook; NYSE BestQuotes; BATS ECN Pinksheets; EBS; LSE; TRACE; TradeWeb; OPRA; and any of approximately two hundred and fifty other examples currently.
Order management systems such as: GL trade; Fidessa RoyalBlue; Orc; Ion Trading.
Complex event processing systems such as Streambase; Aleri; VhaYu; KX; Coral8; to name only a few, as well as other systems that supply market data or data derived from market data, such as, for example, position-keeping systems, risk management systems, and the like.

The invention, and applications using the invention, are also compatible with the infrastructure according to the content integration framework, plug-able JMS and content routing taught in PCT/US2007/006501, PCT/US2007/006500, and PCT/US2007/006426 respectively. When so used, the invention supports additional capabilities such as alternate symbology resolution and load-balancing.

The JMS interface is widely known, and a basic understanding is presumed in understanding the invention taught herein. One may easily obtain such a familiarity with the JMS interface by a review of any excellent and widely available sources.

To enable the implementation, the JMS interface must be mapped to an underlying Application Programming Interface (API) or protocol. It can be appreciated to those of skill in the art that for the purposes of the invention, and the discussion, the terms API and protocol are interchangeable. For example, mapping to Reuters (RMDS) API, or mapping to any Market Data System as described hereinabove. The specifics of this mapping vary according to any particular underlying API. Mapping is well understood and within the purview of the average developer, and is not detailed here. As used herein, for the purpose of illustration, underlying API refers to a proprietary financial market data system API.

The preferred embodiment of the invention presumes access to a programming library (e.g. Java jar file, C# or C++ DLL) that delivers market data via the Java Message Service (JMS) API.

Once an underlying API has been mapped, the inventive standardized JMS interface may be implemented as to the underlying API. An Application, using the JMS publish/subscribe messaging paradigm through the inventive standardized JMS interface, can access financial market data from

TopicConnectionFactory—the preferred embodiment relies on multiple implementations of this JMS abstraction. First, for each different type of embedded API or protocol, there is an implementation of this construct (i.e. TopicConnectionFactory) that allocates TopicConnection objects that are specific to a given embedded implementation. Second, there can be implementations of this construct that support allocation of multiple implementations of TopicConnection such that a single application has more than one type of TopicConnection active at a given time. Among other things, this means that the embodiment of this invention can co-exist within the architectural framework described in infrastructure according to the content integration framework, plug-able JMS and content-aware routing taught in PCT/US2007/006501, PCT/US2007/006500, and PCT/US2007/006426 respectively.

TopicConnection—an embedded implementation of this JMS abstraction creates a connection to the underlying Market Data System using the specific capabilities of the API for that Market Data System. A TopicConnection is responsible for interacting with any authentication mechanisms required by the underlying Market Data System; it also provides the means to create TopicSession objects.

TopicSession—an embedded implementation of this JMS abstraction serves as a factory for Topics. It—TopicSession—also tracks the state of services or data sources exposed via the underlying Market Data System API. As such, it is responsible for monitoring the state of those services as necessary and generating any required status messages that must be passed to the application as MapMessages. The TopicSession is responsible for mapping Topic names to the naming mechanism and conventions of the underlying Market Data System. Optionally, the TopicSession can maintain special Topics whose function is to deliver indications of service existence and state to the Application independently of the notifications sent via specific Topics. This allows, for example, an Application to build and maintain a table of available services. The TopicSession also manages a list of subscriptions corresponding to the Topics for which the Application has registered subscribers.

Topic—an embedded implementation of the JMS Topic abstraction is responsible for routing messages from the underlying Market Data System to one or more subscribers allocated by an Application. When all subscribers have been released, the embedded implementation must ensure that any associated resources on the underlying Market Data System are released. Effectively the Topic must keep a count of all subscribers. When the subscriber count reaches zero, the Topic must unsubscribe from the underlying Market Data System.

MapMessage—an embedded implementation of the JMS MapMessage abstraction is responsible for decoding messages from the underlying Market Data System, format/representation and representing them in the JMS MapMessage structure. It must do this for data messages (images and updates) and status messages. Data values are assigned names and values are placed into the map message using those names as a key. Decoding and mapping the underlying data appropriately may require some external meta-data. The specifics will vary from one implementation to another. In each implementation, the resulting message uses the Application-level conventions for financial market data expressed using the standard JMS property construct. The conventions allow for the conveyance of the following properties: message type (image, update, or status), data condition (stale, not stale), request status (OK, access denied, invalid request, etc), and text.

It can be appreciated that alternate embodiments of this invention may not use MapMessage but rather use another JMS message type such as TextMessage (e.g., XML), ByteMessage (e.g., an encoding such as FIX Adapted for Streaming), or ObjectMessage. The preferred embodiment uses MapMessage because it is follows a paradigm that is most familiar to financial market data application developers and easiest to integrate in most streaming financial market data applications.

TopicSubscriber—an embedded implementation of the JMS TopicSubscriber abstraction is responsible for maintaining the state of an individual subscription within the application. By maintaining such state the TopicSubscriber can ensure that the application receives an image for each individual subscriber and that the events are delivered in proper flow and sequence.

We now describe the basic sequence of events, according to the inventive JMS API for standardized access to Market Data Systems, for an Application subscribing to market data as well as the responsibilities of the various API components in implementing the interaction, as follows:
1. Application allocates a TopicConnectionFactory.
2. Application requests a TopicConnection from the TopicConnectionFactory.
3. TopicConnectionFactory allocates a TopicConnection—the specific type of TopicConnection allocated may vary depending on external configuration, and simultaneous use of multiple types of connections is to be expected—although these details are hidden from the Application.
4. TopicConnection authenticates Application.
5. Application “starts” the TopicConnection.
6. TopicConnection allocates any necessary resources (including separate light-weight threads if necessary) so as to maintain and operate a connection to the underlying Market Data System.
7. Application requests a TopicSession from the TopicConnection.
8. Application requests a Topic from the TopicSession.
9. TopicSession allocates and saves a reference to the requested Topic.
10. Application obtains a TopicSubscriber for the Topic from the TopicSession.
11. TopicSession initiates a subscription with the underlying Market Data System, mapping the Topic name to the naming conventions of the underlying Market Data System as required.
12. TopicSession receives messages in the underlying native format of the Market Data System and converts them to JMS MapMessage with the appropriate application-level conventions as defined by this invention
13. Application receives a stream of MapMessages via the TopicSubscriber and interprets the message properties according to the application-level conventions, and uses the MapMessage interface to access data values by name.
14. Application uses the TopicSession to un-subscribe from the Topic.
15. TopicSession tracks the number of active subscriptions and, when the number is zero, releases any subscriptions and associated resources allocated within the underlying Market Data System.

In the case where a topic is mapped to some type of collection, e.g. an order book or a portfolio, the Application needs to receive multiple data streams and to associate messages with the proper stream. This is the purpose of the stream id property. The preferred embodiment assigns an arbitrary stream id to each data stream. All subsequent messages for a data stream can be correlated with that stream using the data stream id. The next/previous id properties are used to convey ordered collections. In the case of ordered collections, the preferred embodiment can convey changes to the structure of collections by passing message that update the next/previous ids for the various streams.

In the case where the underlying protocol is a stateless broadcast protocol, e.g. a typical exchange protocol, the embodiment of the invention must build and maintain state for all data streams. This may entail building a cache of data values such that the embodiment may deliver full images in response to initial subscription requests. Embedding the embodiment of [Content Integration Framework, described fully in PCT/US2007/006501 is one way to implement this invention.

This invention applies to all types of applications that might be developed to use proprietary APIs for the various Market Data Systems on the market. Other implementations not recited here will be within the scope of the invention, as such implementations may occur to those of skill in the art upon acquiring an understanding of the invention taught herein.

1. An improved system for delivering market data from Market Data Systems to an application, where the Market Data Systems have proprietary APIs, and where the application where the improvement is data access and delivery via a standards-based API, such that an application can use a single API to access multiple different Market Data Systems or switch from one Market Data System.

2. The system as in claim 1 wherein the standards—based API is a JMS API, and wherein some programming library delivers market data from Market Data Systems via the JMS API, enabling an application to access market data from Market Data Systems though a standardized interface using the JMS publish/subscribe paradigm, and wherein said standardized interface relies on a small set of conventions to convey market data semantics via the standard JMS message property construct.

3. The system as in claim 2 wherein the set of conventions is as follows:
Message type, to distinguish different types of messages {status, image, update, stream update};
Status code, to convey request responses {ok, invalid, denied, closed};
Data condition code, to convey data condition {ok, stale};
Text, to convey information text for human users;
Data stream id, to differentiate multiple data streams on one topic; and
Next/previous stream ids, to convey ordered collections.

4. The system, as in claim 2, wherein said interface delivers market data from Market Data Systems to an application as JMS MapMessages.

5. The system, as in claim 3, wherein Market Data System includes Reuter's Market Data System (RMDS).

6. The system, as in claim 3, wherein Market Data System includes at least one of any of the following: market data middleware, real-time datafeed, direct exchange feed, order management system, complex event processing system.

7. A method whereby an Application may, using a JMS API, subscribe to market data in one or more Market Data Systems, and deliver data to a User by output means such as computer display, where such Market Data Systems may use APIs different from each other and proprietary, said method comprising the steps of:
a) Application allocates a TopicConnectionFactory;
b) Application requests a TopicConnection from the TopicConnectionFactory;
c) TopicConnectionFactory allocates a TopicConnection;
d) TopicConnection authenticates Application;
e) Application “starts” the TopicConnection;
f) TopicConnection allocates any necessary resources so as to maintain and operate a connection to the underlying Market Data System;
g) Application requests a TopicSession from the TopicConnection;
h) Application requests a Topic from the TopicSession;
i). TopicSession allocates and saves a reference to the requested Topic;
j) Application obtains a TopicSubscriber for the Topic from the TopicSession;
k) TopicSession initiates a subscription with the underlying Market Data System, mapping the Topic name to the naming conventions of the underlying Market Data System as required;
l) TopicSession receives messages in the underlying native format of the Market Data System and converts said messages to JMS MapMessage with the appropriate application-level conventions;
m) Application receives a stream of MapMessages via the TopicSubscriber and interprets the message properties according to the application-level conventions, and uses the MapMessage interface to access data values by name;
n) Application uses the TopicSession to un-subscribe from the Topic; and
o) TopicSession tracks the number of active subscriptions and, when the number is zero, releases any subscriptions and associated resources allocated within the underlying Market Data System.

8. The method of claim 7, wherein the appropriate application level—conventions of step l) are selected from the following set:
Message type, to distinguish different types of messages {status, image, update, stream_update};
Status code, to convey request responses {ok, invalid, denied, closed};
Data condition code, to convey data condition {ok, stale};
Text, to convey information text for human users;
Data stream id, to differentiate multiple data streams on one topic; and
Next/previous stream ids, to convey ordered collections.

9. The method, as in claim 8, wherein Market Data System includes at least one of any of the following: market data middleware, real-time datafeed, direct exchange feed, order management system, complex event processing system.

10. The method. as in claim 8. wherein Market Data System is RMDS (Reuter's Market Data System).
